(19) United States
(12) Patent Application Publication
(10) Pub. No.: US 2003/0153349 A1
(43) Pub. Date: Aug. 14, 2003

(54) Mobile phone with replaceable key modules

(75) Inventor: Hsueh-Wen Sun, Shinjuang City (TW)

Correspondence Address: Richard P. Berg, Esq., c/o LADAS & PARRY, Suite 2100, 5670 Wilshire Boulevard, Los Angeles, CA, 90036-5679, US

(73) Assignee: BENQ CORPORATION

(21) Appl. No.: 10/241,921

(22) Filed: Sep. 12, 2002

(30) Foreign Application Priority Data
Feb. 8, 2002 (TW) 91201738

(51) Int. Cl. H04M 1/00; H04B 1/38

(52) U.S. Cl. 455/550; 455/557

(57) ABSTRACT

A mobile phone with replaceable key modules. The mobile phone comprises a body and a key module. The key module is disposed on the body in a replaceable manner, and is electrically coupled to the body. The key module comprises a key assembly, a printed circuit board, and a housing. The key assembly includes a plurality of keys, and the printed circuit board includes a plurality of pads corresponding to the keys respectively. The housing is disposed outside the key assembly.

### BACKGROUND OF THE INVENTION

1. Field of the Invention

The invention relates to a mobile phone; in particular, the invention relates to a mobile phone with replaceable key modules.

2. Description of the Related Art

Due to the boom in modern technology for communication, mobile phones have become a daily necessity for users. In order to grasp the trend, telecommunication manufacturers focus on enhancing function in the phones. Presently, each of the mobile phones has only one key assembly; that is, the key assembly is built into the body of the mobile phone. Thus, the key assembly cannot be replaced.

As mobile phone functions increase, only one key assembly cannot handle all of the functions. For example, when the user wants to play games built into the mobile phone, it is very inconvenient to control via the original key assembly. In addition, as mobile phone functions increase, the design of the key assembly becomes complicated. For the elders and children, the original key assembly may be difficult to read; therefore, they may press the wrong key during operation.

### SUMMARY OF THE INVENTION

In order to overcome the disadvantages of the aforementioned mobile phone, the invention provides a mobile phone with replaceable key modules.

Another purpose of this invention is to provide a replaceable key module for a mobile phone.

Accordingly, the invention provides a mobile phone with replaceable key modules. The mobile phone comprises a body and a key module. The key module is disposed on the body in a replaceable manner, and is electrically coupled to the body.

In a preferred embodiment, the body includes a first connector, and the key module includes a second connector corresponding to the first connector. Thus, the key module is electrically coupled to the body by the second connector contacting the first connector.

Furthermore, the body includes a first printed circuit board electrically coupled to the first connector, and the key module includes a second printed circuit board electrically coupled to the second connector. Thus, the second printed circuit board is electrically coupled to the first circuit board by the second connector contacting the first connector.

In another preferred embodiment, the body includes an engaging member, and the key module includes a slot corresponding to the engaging member. Thus, the key module is disposed on the body by the engaging member engaging with the slot.

Furthermore, the body includes a hole, and the key module includes a protrusion corresponding to the hole. Thus, the key module is disposed on the body by the protrusion being inserted into the hole.

In another preferred embodiment, the key module comprises a key assembly, a second printed circuit board, a housing, and a backlight device. The key assembly includes a plurality of keys, and the second printed circuit board includes a plurality of pads corresponding to the keys respectively. The housing is disposed outside the key assembly. The backlight device is disposed inside the housing to backlight the key module.

In another preferred embodiment, this invention provides an electronic device with replaceable key modules. The electronic device comprises a body and a key module. The key module is disposed on the body in a replaceable manner, and is electrically coupled to the body.

### BRIEF DESCRIPTION OF THE DRAWINGS

The invention is hereinafter described in detail with reference to the accompanying drawings in which:

FIG. 1a is an exploded view of a mobile phone as disclosed in this invention;

FIG. 1b is a front view of the assembled mobile phone in FIG. 1a;

FIG. 2a is another exploded view of a mobile phone as disclosed in this invention;

FIG. 2b is a front view of the assembled mobile phone in FIG. 2a;

FIG. 3a is another exploded view of a mobile phone as disclosed in this invention;

FIG. 3b is a front view of the assembled mobile phone in FIG. 3a;

FIG. 4a is another exploded view of the mobile phone in FIG. 1a;

FIG. 4b is another exploded view of the mobile phone in FIG. 1a;

FIG. 4c is another exploded view of the mobile phone in FIG. 1a; and

FIG. 5 is an exploded view of a key module as disclosed in this invention.

### DETAILED DESCRIPTION OF THE INVENTION

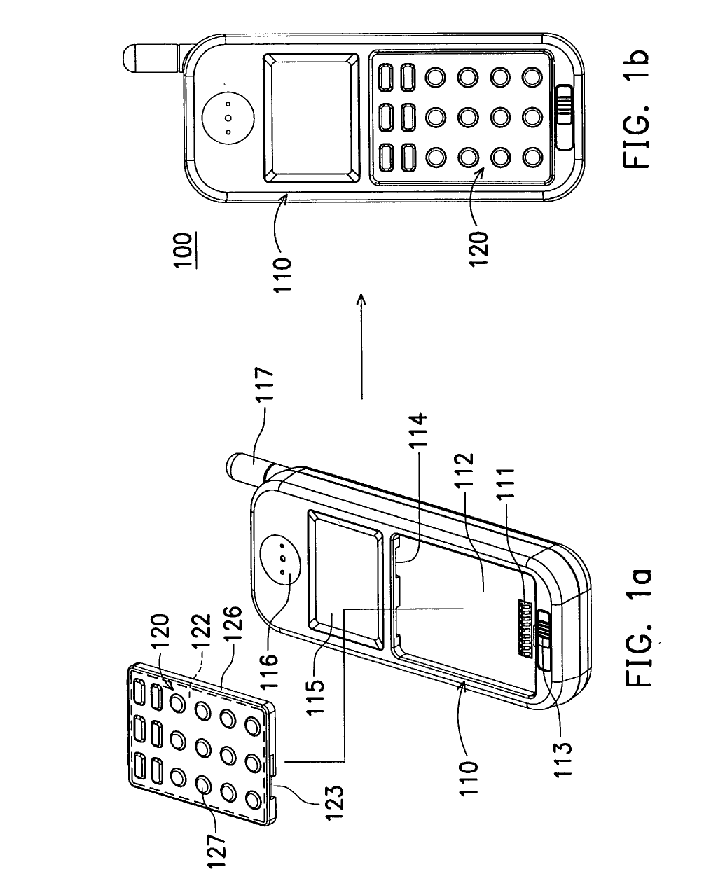

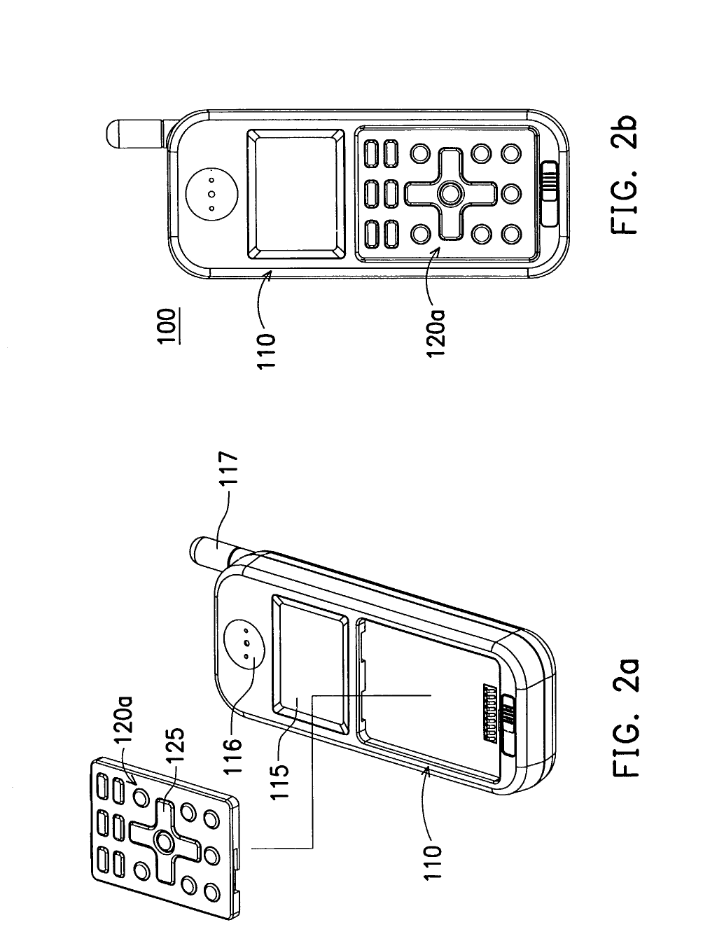

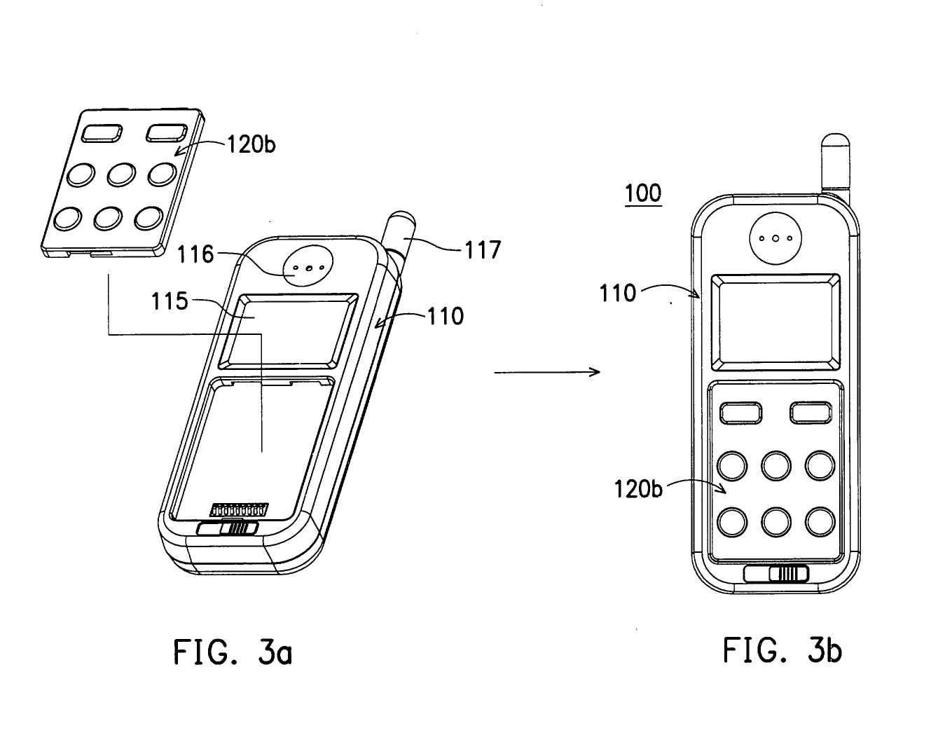

Referring to FIG. 1a, FIG. 1b, FIG. 2a, FIG. 2b, FIG. 3a, and FIG. 3b, a mobile phone 100 as disclosed in this invention is provided. The mobile phone 100 comprises a body 110, and a plurality of key modules 120, 120a, 120b.

The body 110 is a basic element of the mobile phone 100, and includes a first connector 111, a first printed circuit board 112, an engaging member 113, two holes 114, a screen 115, a speaker 116, and an antenna 117 and so on.

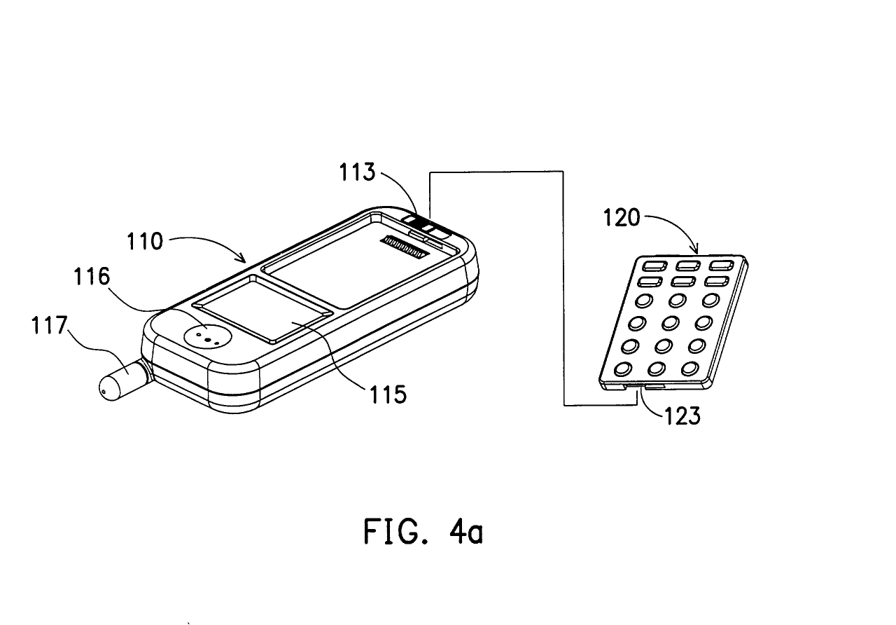

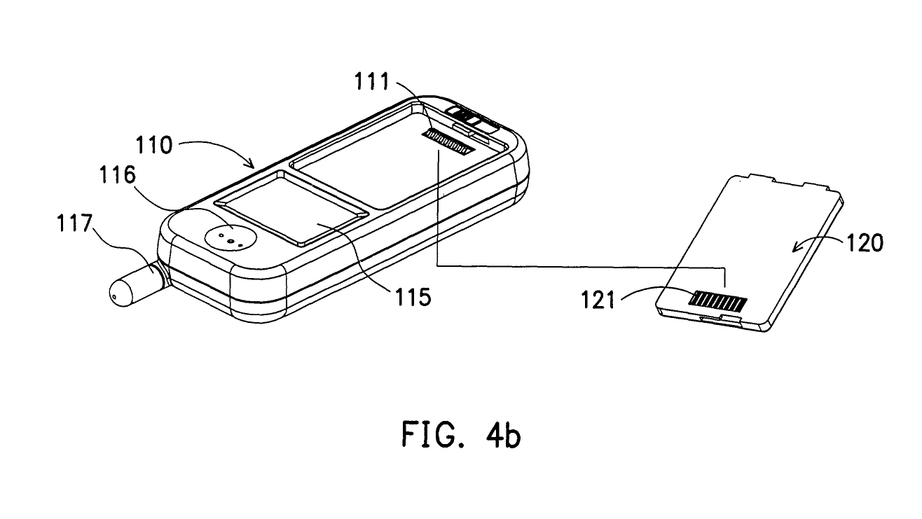

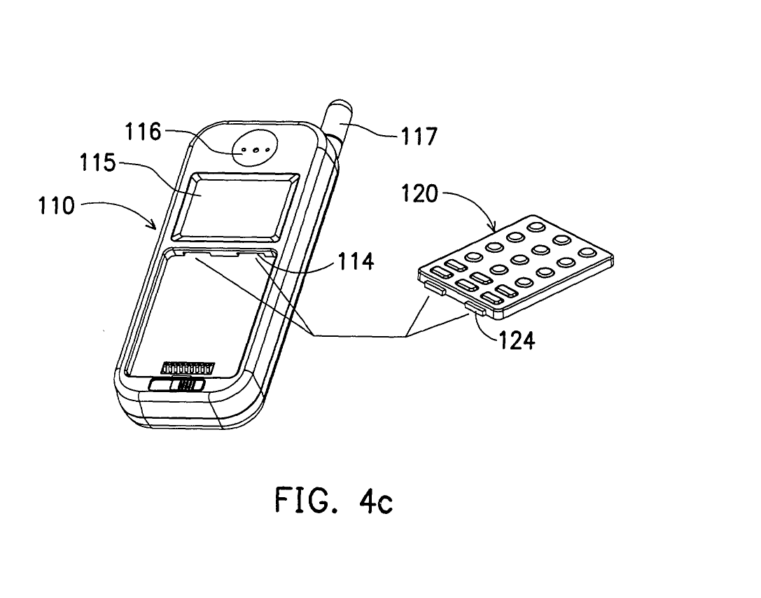

Referring to FIG. 4a, the engaging member 113 can move leftward and rightward so as to engage with the key modules 120, 120a, 120b.

The key modules 120, 120a, 120b are disposed on the body 110 in a replaceable manner; that is, only one of the key modules 120, 120a, 120b can be assembled to the body 110 at the same time, and the key module disposed on the body 110 can be replaced. Each of the key modules 120, 120a, 120b includes a second connector 121, a second printed circuit board 122, a slot 123, and two protrusions 124. As shown in FIG. 4b, the second connector 121 corresponds to the first connector 111 of the body 110. The second printed circuit board 122 is electrically coupled to the second connector 121, and the slot 123 corresponds to the engaging member 113 of the body 110. As shown in FIG. 4c, the protrusions 124 correspond to the holes 114 of the body 110.

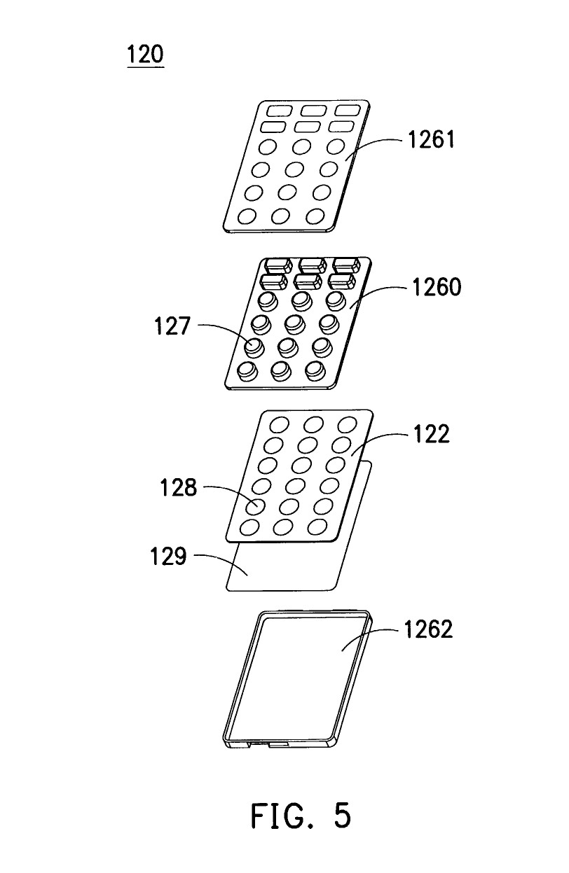

Specifically, referring to FIG. 1a, the key module 120 comprises the second printed circuit board 122, the second connector 121 as shown in FIG. 4b, and a plurality of keys 127 as shown in FIG. 5. The second printed circuit board 122 includes a plurality of metal pads 128 as shown in FIG. 5. Each of the pads 128 corresponds to the keys 127 respectively. The second printed circuit board 122 is electrically coupled to the first printed circuit board 112 of the body 110 by the second connector 121 electrically coupling to the first connector 111 of the body 110. When the key module 120 is disposed on and electrically coupled with the body 110, the input function of the mobile phone 100 can be performed by the keys 127 contacting the pads 128.

The key module 120, as shown in FIG. 1a, can be used as a standard type, and is suitable for normal use. The key module 120a, as shown in FIG. 2a, can be used as a game interface, and provided with a + key 125. When the user wants to play games built into the mobile phone 100, the key module 120a can be disposed on the body 110. The key module 120b, as shown in FIG. 3a, can be used as a simple type, and is suitable for those for whom normal operation may be difficult.

When one of the key modules 120, 120a, 120b is assembled to the body 110, the key module 120, 120a, 120b is electrically coupled to the body 110 by the second connector 121 contacting the first connector 111. Also, the second printed circuit board 122 is electrically coupled to the first circuit board 112 by the second connector 121 contacting the first connector 111, and the key module 120, 120a, 120b is fixedly disposed on the body 110 by the engaging member 113 engaging with the slot 123 and the protrusions 124 inserting into the holes 114.

Referring to FIG. 5, each of the key modules 120, 120a, 120b further comprises a housing 126, a key assembly 1260, and a backlight device 129. The housing 126 is used as a body of the key modules 120, 120a, 120b, and includes a cover 1261 and a base 1262. The base 1262 is disposed inside the body 110 of the mobile phone 100. The key assembly 1260 includes the keys 127 to provide the input function of the mobile phone 100. The backlight device 129 is disposed in the base 1262 of the housing 126, to backlight the key modules 120, 120a, 120b.

As stated above, in the mobile phone as disclosed in this invention, the key modules can be replaced as required by different conditions.

It is understood that the concept of this invention is not limited to the mobile phone, and it can be applied for other electronic devices using key modules.

While the invention has been particularly shown and described with reference to a preferred embodiment, it will be readily appreciated by those of ordinary skill in the art that various changes and modifications may be made without departing from the spirit and scope of the invention. It is intended that the claims be interpreted to housing the disclosed embodiment, those alternatives which have been discussed above, and all equivalents thereto.

What is claimed is:

1. A mobile phone comprising:
a body; and
a key module disposed on the body in a replaceable manner and electrically coupled to the body.

2. The mobile phone as claimed in claim 1, wherein the body includes a first connector, and the key module includes a second connector corresponding to the first connector, whereby the key module is electrically coupled to the body by the second connector contacting the first connector.

3. The mobile phone as claimed in claim 2, wherein the body includes a first printed circuit board electrically coupled to the first connector, and the key module includes a second printed circuit board electrically coupled to the second connector, whereby the second printed circuit board is electrically coupled to the first circuit board by the second connector contacting the first connector.

4. The mobile phone as claimed in claim 1, wherein the body includes an engaging member, and the key module includes a slot corresponding to the engaging member, whereby the key module is disposed on the body by the engaging member engaging with the slot.

5. The mobile phone as claimed in claim 4, wherein the body includes a hole, and the key module includes a protrusion corresponding to the hole, whereby the key module is disposed on the body by the protrusion being inserted into the hole.

6. The mobile phone as claimed in claim 1, wherein the key module comprises:
a key assembly including a plurality of keys;
a second printed circuit board, including a plurality of pads corresponding to the keys respectively; and
a housing disposed outside the key assembly.

7. The mobile phone as claimed in claim 1, wherein the key module further comprises:
a backlight device, disposed inside the housing, for backlighting the key module.

8. An electronic device comprising:
a body; and
a key module disposed on the body in a replaceable manner and electrically coupled to the body.

9. The electronic device as claimed in claim 8, wherein the body includes a first connector, and the key module includes a second connector corresponding to the first connector, whereby the key module is electrically coupled to the body by the second connector contacting the first connector.

10. The electronic device as claimed in claim 9, wherein the body includes a first printed circuit board electrically coupled to the first connector, and the key module includes a second printed circuit board electrically coupled to the second connector, whereby the second printed circuit board is electrically coupled to the first circuit board by the second connector contacting the first connector.

11. The electronic device as claimed in claim 8, wherein the body includes an engaging member, and the key module includes a slot corresponding to the engaging member, whereby the key module is disposed on the body by the engaging member engaging with the slot.

12. The electronic device as claimed in claim 11, wherein the body includes a hole, and the key module includes a protrusion corresponding to the hole, whereby the key module is disposed on the body by the protrusion being inserted into the hole.

13. The electronic device as claimed in claim 8, wherein the key module comprises:
a key assembly including a plurality of keys;
a second printed circuit board, including a plurality of pads corresponding to the keys respectively; and
a housing disposed outside the key assembly.

14. The electronic device as claimed in claim 13, wherein the key module further comprises:
a backlight device, disposed inside the housing, for backlighting the key module.

15. A replaceable key module comprising:
a key assembly including a plurality of keys;
a printed circuit board including a plurality of pads corresponding to the keys respectively; and
a housing disposed outside the key assembly.

16. The key module as claimed in claim 15, further comprising:
a backlight device, disposed inside the housing, for backlighting the key module.
